(19) United States
(12) Patent Application Publication
(10) Pub. No.: US 2010/0279096 A1
(43) Pub. Date: Nov. 4, 2010

(54) Flooring and Wall Fabric

(76) Inventor: STEVEN COUCH, CHATTANOOGA, TN (US)

Correspondence Address: Steve Couch, 2908 Highway 41 South, Dalton, GA, 30722, US

(21) Appl. No.: 12/726,465

(22) Filed: Mar. 18, 2010

Related U.S. Application Data
(60) Provisional application No. 61/161,207, filed on Mar. 18, 2009.

(51) Int. Cl. B32B 5/02

(52) U.S. Cl. 428/221

(57) ABSTRACT

The invention is a performance fabric having an outer exposed layer of coated core-filled yarns, such as those having a polyvinylchloride coating surrounding a polyester core, or even non-core filled yarn such as polyvinylchloride yarns woven to form an upper layer which is connected to a polyester or other core layer, preferably with an adhesive such as a weatherproof adhesive, and a preferred urethane backing coating applied to a lower surface of the core layer.

### REFERENCE TO RELATED APPLICATIONS

This application claims an invention which was disclosed in Provisional Application No. 61/161,207, filed Mar. 18, 2009, entitled “Flooring and Wall Fabric”. The benefit under 35 USC §119(e) of the U.S. provisional application is hereby claimed, and the aforementioned application is hereby incorporated herein by reference.

### BACKGROUND OF THE INVENTION

Chilewich, LLC, has a core filled yarn product which relies in part on PVC (polyvinyl chloride) coated ceramics, namely, fiberglass. In practice, this woven material is then coated with a PVC backing as described in the reference which could bleed through the upper surface when applied. Bow and skew are other problems with this technique which can produce undesirable results. Lately, that manufacturer has apparently achieved better quality control to reduce bleed through effects in its products. While that is certainly one way of producing woven product to the market place, other and/or better options are believed to be attractive. After three years of trial and error, the applicant has finally arrived at an improved flooring product which is believed to overcome some of the disadvantages associated with the prior art products such as that disclosed in U.S. Pat. No. 7,326,661, which was previously published as U.S. Published Patent Application No. 2005/0255775.

Also, U.S. Pat. No. 7,351,672 teaches a convertible top fabric, which distinctly claims an inner and outer layer with a waterproofing adhesive layer between. Fortunately, this construction is believed to be strictly directed towards convertible tops for use in automobiles, with the inner layer functioning as a headliner. There is no teaching or suggestion that that technology could be applied to any other use. Furthermore, this reference would teach away from providing another layer which could cover up the two layers provided by this reference, since one is for an external environment impact, and the other serves as a “headliner.”

In the caret industry, coating carpets with urethane to provide a cushioning effect is known. After tufting carpet with a tufting machine, the tufted carpet is then sent to one of relatively small number of coating companies which unroll the carpet in an upside down configuration, and apply the coating with a doctor's blade to a desired depth. The coating is then cured as a backing on the carpet in an oven. In addition to providing cushioning, the urethane also assists in locking the tufts, which extend through the backing, so that the yarns do not pull free.

### FIELD OF THE INVENTION

The invention pertains to the field of flooring and wall fabric. More particularly, the invention pertains to a performance fabric having an outer exposed layer of coated core-filled yarns, such as those having a polyvinylchloride coating surrounding a polyester core, or even non-core filled yarn such as polyvinylchloride yarns woven to form an upper layer which is connected to a polyester or other core layer, preferably with an adhesive such as a weatherproof adhesive, and a preferred urethane backing coating applied to a lower surface of the core layer.

### SUMMARY OF THE INVENTION

It is a present object of the present invention to provide an improved flooring product.

It is another object of the present invention to provide and improved wall covering product.

It is another object of the present invention to provide a urethane backed core fabric layer (i.e. not tufted carpet) such as one made of polyester, which is then connected to an upper surface layer having a PVC, core-filled yarn, a PVC yarn, and/or a polypropylene surface layer.

Accordingly, a first presently preferred embodiment of the invention contemplates at least one core filled yarn woven in an upper layer, whether it has polyvinyl chloride (PVC), coating polyester, or otherwise, a PVC (non-coated) yarn, polypropylene yarn, and/or one which may also incorporate other materials in an upper layer. This fabric upper layer is preferably adhesive connected to a core layer which is preferably a fabric polyester non-woven, although it could be a variety of other materials other than tufted carpet. Before adhesively connecting the polyester core to the upper layer, it is preferred that the core first be coated with a urethane, to provide a desired amount of cushion, as one would expect on a floor covering product. The backing coated core layer is then cured. After curing the backing on the core layer, the adhesive is applied with the upper layer. The adhesive then cures/sets. An advantage of this construction is that is provides an essentially, if not waterproof product that provides UV (ultraviolet) stability, an antimicrobial upper and lower surface, and/or flame retardancy as a flame applied to the upper surface would be extinguished upon melting by the polyester core layer, which is also fire resistant.

A second presently preferred embodiment includes a polypropylene surface layer, which is provided as a woven product. This high end product is virtually stain proof Red wine can be poured on it, and wiped right off. The polypropylene does not absorb most stains, and the waterproof nature of the adhesive prevents it (liquids) from quickly soaking into the polyester core layer when utilized. Finally, the urethane backing layer provides cushioning for a fabric (not for a carpet).

Finally, a third embodiment contemplates a wall covering embodiment, wherein the urethane layer may not be applied. This can keep the total thickness of the wall covering relatively thin. Of course, if thicker is desired, such as for additional sound dampening and/or other reasons, urethane could be applied as a base coating behind the core layer

### BRIEF DESCRIPTION OF THE DRAWING

The particular features and advantages of the invention, as well as other objects, will become apparent from the following description, taken in connection with the accompanying drawings, in which:

FIG. 1 shows a top plan view of a fabric constructed in accordance with a presently preferred embodiment of the present invention.

FIG. 2 shows a cross sectional view taken along line A-A in FIG. 1; and

FIG. 3 shows an alternative cross sectional view of an alternative of the presently preferred alternative embodiment of the present invention.

### DETAILED DESCRIPTION OF THE INVENTION

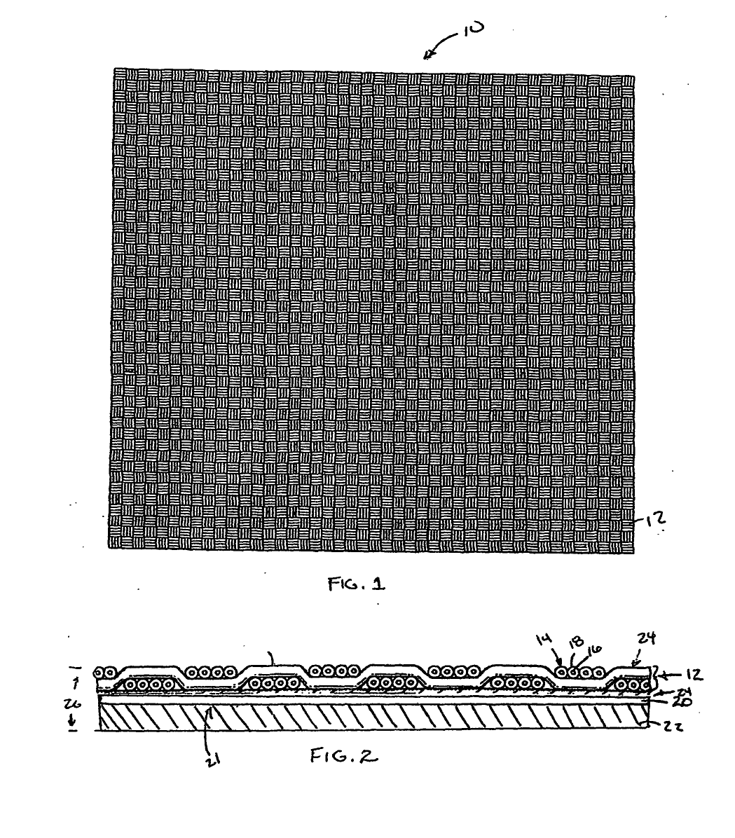

FIG. 1 shows a flooring or fabric product 10 constructed in accordance with a presently preferred embodiment of the present invention. Fabric product 10 is preferably comprised of an upper layer 12, which is preferably a woven upper layer. All methods of weaving would be suitable, including with a limited dobby, jacquard, plain weaving, and others. In fact, the embodiment of FIG. 3 shows a different weave pattern, which will be discussed in further detail as it relates to that embodiment in which alternating single threads appear, as opposed to the four threaded pattern shown in FIG. 1. It will be understood by those of ordinary skill in the art that further embodiments could be provided, such as four yarns in one direction and a single yarn in the perpendicular direction, and all sorts of other weaving patterns known in the art.

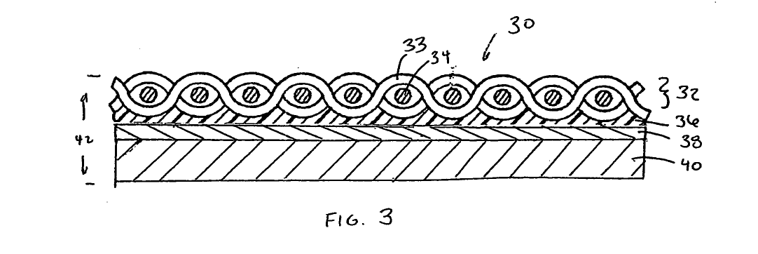

FIG. 2 better illustrates the nature of the yarns utilized in that a core filled yarn 14 is provided at least for some embodiments. In particular, a polyester core 16 is illustrated as coated with a polyvinylchloride (PVC) coating 18. With a desired upper layer 12 identified, the manufacturer can then begin to prepare the flooring product 10. Specifically, a suitable core layer 20 is selected, which, in the presently preferred embodiment, is a polyester non-woven. Various other materials and/or textures such as woven materials, knitted materials, etc., could be utilized. The core layer is connected to backing 22 by coating a bottom 21 of the core layer 20 (i.e. usually with the core layer 20 inverted) and then preferably curing in an oven. After coating the core layer 20 with the now cured coating 22, which is preferably a urethane, an adhesive layer 24 is then preferably utilized, to connect the upper layer 12 to the core layer 20. Curing in an oven may also be employed, to securely connect the upper layer 12 to the core layer 20, utilizing the adhesive layer 24 possibly after passing through rollers.

In the presently preferred embodiment, adhesive layer 24 provides a significant, if not substantial, if not complete, waterproofing. Water or other fluids which could not otherwise contact the upper layer 12, and proceed toward the core layer 20, may be at least significantly blocked by adhesive layer 24.

By selecting a core layer 20 as polyester fabric, the fabric product 10 can be nonflammable, or at least flame retardant. Accordingly, an exposed flame could be at least partially extinguished by the core layer 20.

Upper layer 12 having a core filled yarn 14 can have additives such as UV stability, antimicrobials, flame retardancy, and/or other properties to provide a performance fabric 10. Furthermore, urethane and/ or other backing layer 22 could assist in providing cushioning to the floor product 10. Providing a backing layer 22 on a fabric is believed to be a novel product development.

Non-core filled yarns could be utilize in addition to, or instead of, core filled yarns, in the presently preferred embodiment. For such an embodiment, polyester core pre-coated yarn as illustrated, could be utilized in combination with one or more PVC yarns 24 that are not core filled to provide first layer 12 in a preferred embodiment. Depending on the twist and/or yarn selection, various attractive textures and colorations can be provided.

This fabric product 10 can be utilized with indoor or outdoor flooring uses, and can be provided as area rugs, broadloom, tile, and/or other flooring applications, such as boat carpet and possibly others. Other non-flooring embodiments may also be employed.

The adhesive layer 24 has been provided to have a moisture barrier of approximately 85% to 90% in a presently preferred embodiment. Other moisture barrier percentages can be provided with other embodiments. Important considerations for at least some embodiments may include an ability to provide flame retardancy, and an ability to not tear apart. Other prototype designs in the development process were particularly sensitive to de-lamination or tearing apart.

By providing fabric 10 of the preferred embodiment, many uses are anticipated. Fabric 10 works particularly well in outdoor applications to coordinate with patio furniture, as well as to surround portions of pool areas, particularly to overlay cracked and/or repaired concrete for a more desirable aesthetic appeal. Such uses as nursing home environments, which may have urine accidentally spilled on the floor, and/or other locations which may be subjected to staining issues with other flooring alternatives may be particularly well suited for this embodiment.

Another embodiment of the present invention is shown in FIG. 3, for use as a wall covering or other use. Fabric 30 is a woven alternating yarn 33,34 pattern for upper layer 32. Upper layer 32 is illustrated connected by adhesive layer 36 to core layer 38, which is supported by backing 40. That construction is similar to that as shown in FIGS. 1 and 2, except that there is a slightly different weave pattern for upper layer 32. Other weave patterns would be acceptable in the various embodiments.

Another difference of the embodiment of FIG. 3 relative to FIG. 2 can include that the upper layer 32 may be comprised of polypropylene yarns 33,34 instead of polyvinylchloride (PVC) (whether coated or not) yarns.

Woven polypropylene fabric has not traditionally been utilized as a fabric wear layer (i.e. an upper layer) for flooring. In the applicant's design, the upper layer 32 is woven for durability and light fastness. Polypropylene as a wear layer in flooring, particularly a woven flooring fabric, is not believed to exist in the prior art. However, due to its stain resistance, and inability to absorb stain, it is believed by the applicant to provide a particularly attractive flooring option. The inventor has poured red wine on this embodiment, and been unable to provide a permanent stain on it. The adhesive layer 36 may be various adhesives as are known in the art. The applicant has utilized substantially water proof adhesive successfully. The core layer 38 is illustrated as a polyester non-woven fabric. The backing layer 40 may be a urethane layer connected as described above.

While the fabric product 10 could be utilized in the exact form as described above as a wall covering embodiment (i.e., wall paper) with the backing 40, it is anticipated that for other wall covering embodiments may lack backing layers 22 or 40, and/or possibly have a pre-glue layer for wallpaper applications or otherwise be able to have wallpaper or other glue applied and then connected to wall surfaces. Of course, the backing layers 22,40 could provide additional sound proofing characteristics or other properties for various other embodiments for wall covering.

Other uses for the presently preferred embodiments may be encountered by various users. The applicant is preparing to distribute computer mouse pads to decorators which are constructed identically to the embodiments shown in FIGS. 1-3 for use by designers in evaluating the new floor covering technology. Die cutting the mouse pad from fabric 10 has worked well for all embodiments.

When manufacturing the floor coverings and wallpaper coatings, the applicant has found that it is preferable to coat the core layer 38 with backing 40 to a desired thickness by applying the urethane as a liquid coating to a polyester non-woven core layer 38, and then curing it to a solid in an oven. After first curing the coating on the core layer 38 with backing 40, then a woven first layer 32 or 12 is preferably applied with an adhesive 36, and then once again run through an oven for curing the adhesive layer 36, such as after passing through rollers. Although there exists urethane backed flooring products, none incorporated the types of specific woven faced fabrics described, attached as described.

As one can see from the end products as compared to those existing on the market today, the embodiment utilizing polypropylene as the upper layer 32 is believed to be a particularly attractive option for many applications, in that it provides an attractive surface finish, and appears to be virtually stain proof. On the other hand, an embodiment that is made using PVC provides a particularly attractive flooring surface which can coordinate well with outdoor furniture. Furthermore, still other embodiments may incorporate PVC yarns, whether coated or not, with polypropylene an/or possibly various other materials woven to provide upper layers 12,32 and others.

In the embodiments illustrated, the total thickness 26,42 is about 3/16″ or less than ¼″ while depending upon the thickness of the coating 22 selected. Other thicknesses could be provided for other embodiments.

Numerous alterations of the structure herein disclosed will suggest themselves to those skilled in the art. However, it is to be understood that the present disclosure relates to the preferred embodiment of the invention which is for purposes of illustration only, and not to be construed as a limitation of the invention. All such modifications which do not depart from the spirit of the invention are intended to be included within the scope of the appended claims.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A flooring product as shown and described herein.

2. A wall covering product as shown and described herein.

3. A fabric product as shown and described herein.
